(19) United States
(12) Patent Application Publication
(10) Pub. No.: US 2005/0226098 A1
(43) Pub. Date: Oct. 13, 2005

(54) Dynamic acoustic logging using a feedback loop

(75) Inventors: Ole G. Engels, Houston, TX (US); W. Allen Gilchrist, Houston, TX (US); Douglas J. Patterson, Spring, TX (US); Darryl E. Trcka, Houston, TX (US)

Correspondence Address: MADAN, MOSSMAN & SRIRAM, P.C., 2603 AUGUSTA, SUITE 700, HOUSTON, TX, 77057, US

(73) Assignee: Baker Hughes Incorporated, Houston, TX (US)

(21) Appl. No.: 11/100,284

(22) Filed: Apr. 6, 2005

Related U.S. Application Data
(60) Provisional application No. 60/560,154, filed on Apr. 7, 2004.

(51) Int. Cl. G01V 1/00

(52) U.S. Cl. 367/31

(57) ABSTRACT

The logging tool of this invention includes a segmented transmitter and a plurality of segmented receivers. The transmitter is operable in monopole, dipole or quadrupole modes. The received signals are analyzed, and based on the results of the analysis, one or more operating parameters of the transmitter are altered to improve data quality and/or logging speed.

### CROSS REFERENCES TO RELATED APPLICATIONS

This application claims priority from U.S. Provisional Patent Application Ser. No. 60/560,154 filed on Apr. 7, 2004.

### FIELD OF THE INVENTION

The present invention relates generally to borehole acoustic logging using an acoustic sonde having at least one source for generating acoustic waves and at least one acoustic receiver for detecting the acoustic waves as modified by the surrounding geological formation, and, more particularly, to an apparatus, method and system for dynamically adjusting parameters of the data acquisition based on analysis of data received by the receiver.

### BACKGROUND OF THE INVENTION

Acoustic well logging is an important method for determining the physical characteristics of subterranean geologic formations surrounding a well borehole. Measurement of the unique acoustic wave characteristics in specific geologic formations surrounding the well borehole may define physical characteristics of the formation which indicate the formation's capability of producing oil or gas. Therefore, the measurement of acoustic velocity has become a practical standard for all new wells being drilled.

Acoustic logging tools have traditionally been used to measure the velocity of acoustic waves traveling through the formation surrounding the borehole. The typical acoustic logging tool includes an acoustic energy source to send acoustic waves from the borehole into the formation and one or more acoustic energy receivers to detect the acoustic waves returning from the formation back to the borehole. Logging tools use various types of transducers as transmitters such as, for example, magnetostrictive, piezoelectric, mechanical plunger, or the like for the acoustic energy source. The velocity of the acoustic waves is determined by measuring the time required for the acoustic waves to propagate through the formation from the acoustic source to the acoustic receiver, or the time difference between two or more acoustic receivers. Logging tools use various types of acoustic receiver(s) such as, for example, magnetostrictive, piezoelectric, or the like. The acoustic receiver(s) is used to detect the acoustic waves returning from the geological formation in the general vicinity of where the logging tool is located in the well borehole.

Geological formations vary depending upon the depth of the formations. Acoustic logging determines these varying formations at identifiable depths within the borehole. The various types of formations reflect, transmit, absorb, etc., acoustic waves differently at different frequencies and modes of acoustic propagation. Modes of acoustic propagation may be compressional waves, shear waves, Stoneley waves, or other waveforms well-known and appreciated in the art. Tube waves are the low frequency limit of Stoneley waves. Acoustic logging utilizes these differences to determine the various characteristics of geological formations.

U.S. Pat. No. 5,357,481 to Lester et al, having the same assignee as the present invention, discloses a logging-tool assembly for generating both flexural wavefields and compressional wavefields in the sidewall formations encountered by a borehole. The assembly consists of a sonde constructed of a plurality of segments that are axially rotatable with respect to each other. Each one of two of the segments includes a compartment in which is mounted a dipole bender bar transmitting transducer. Two additional segments each contain one or more binaurally sensitive receiver transducers. Monopole transmitting and receiving transducers are also included in the respective appropriate segments. An acoustic isolator acoustically separates the transmitting transducers from the receiving transducers.

U.S. Pat. No. 5,265,067 to Chang teaches the use of for simultaneously acquiring time-domain (e.g., compressional) and frequency-domain (e.g., monopole Stoneley and/or dipole shear) borehole logs which are separated by frequency filtering. Monopole (Stoneley) data and dipole (shear) data are acquired simultaneously using discrete-frequency sonic emission, preferably at distinct frequencies to avoid cross-mode interference. One embodiment combines discrete-frequency dipole sonic emission at low frequency (up to 5 kHz) to log formation shear wave, high frequency (5 to 30 kHz) time-domain monopole emission with first-motion detection to log formation compressional wave, and discrete-frequency monopole emission at low frequency (below 5 kHz) to log borehole Stoneley wave. The measurements of compressional, shear and Stoneley can be transmitted uphole using a small telemetry bandwidth. This feature could result in higher logging speed due to acquisition of all three measurements in a single logging run, real-time acquisition and processing of the three measurements, and a reduced telemetry load which allows a tool making the three measurements to be combined with other logging tools.

U.S. Pat. No. 6,552,962 to Varsamis et al. teaches a logging-while-drilling dipole logging tool for acoustic measurements in which the received signals are monitored and some filtering of the received signals is done if the background noise exceeds a specified threshold.

The references mentioned above do not take advantage of additional speedup in acquisition time that can be accomplished by judicious choice of the acquisition parameters, as well as improvements in the data quality that are possible. The present invention addresses these deficiencies and provides additional benefits which will be evident to those skilled in the art.

### SUMMARY OF THE INVENTION

The present invention is a method of acquiring acoustic data indicative of properties of an earth formation. A logging tool having at least one transmitter and a plurality of receivers is conveyed in a borehole. The transmitter is activated to generate acoustic waves in a fluid in the borehole, the formation, and/or a wall of the borehole. Signals received at the plurality of receivers are analyzed and the operation of the transmitter is controlled based on the results of the analysis. The received signals comprise may be P-waves propagating through the formation, S-waves propagating through the formation, and/or Stoneley waves. The transmitter may be operated in a monopole mode, a dipole mode, and/or a quadrupole mode. Analyzing the signals may be done performing a transformation to the τ-p domain. A semblance may be determined in the τ-p domain. Controlling the operation of the at least one transmitter may include switching the transmitter from a monopole mode to a dipole mode. Controlling the transmitter further may include altering a frequency of operation. Analyzing of the signals may involve determination of a slowness of P-waves, and/or S-waves. The time sampling interval of the received signals and/or a window length of the received signals may be altered. The frequency of operation may be altered based on measurements of a noise level.

Another embodiment of the invention is an apparatus for acquiring acoustic data indicative of properties of an earth formation. The apparatus includes a logging tool conveyed into a borehole into the earth formation. The logging tool includes at least one transmitter that generates acoustic waves in a fluid in the borehole, the formation, and/or a wall of the borehole. One or more receivers receive signals resulting from the activation of the at least one transmitter. A processor analyzes the received signals and controls operation of the at least one transmitter based on results of the analysis. The transmitter may be operated in a monopole mode, a dipole mode, and/or a quadrupole mode. The processor may analyze the signals by determining a semblance of the signals. The processor may control the operation of the at least one transmitter by selectively switching the transmitter between a monopole mode a dipole mode. The processor may alter the frequency of operation of the transmitter. The processor may analyze the signals by determining a slowness of P-waves, and/or S-waves, and may alter a time sampling interval of the received signals. Alternatively, the processor may alter a window length of the received signals. The processor may alter the frequency of operation of the transmitter based on the noise level of received signals. The apparatus may include a wireline which conveys the logging tool into the borehole.

Another embodiment of the invention is a machine readable medium for use with an apparatus which acquires acoustic data indicative of properties of an earth formation. The apparatus includes a logging tool including at least one transmitter that generates acoustic waves in a fluid in said borehole, the formation, and/or a wall of the borehole. The apparatus also includes a plurality of receivers which receive signals resulting from the activation of the at least one transmitter. The medium includes instructions that enable analysis of the received signals, and enable control of operation of the transmitter based on results of the analysis. The medium may be a ROM, an EPROM, an EAROM, a Flash Memory, and/or an Optical disk.

### BRIEF DESCRIPTION OF THE DRAWINGS

The novel features which are believed to be characteristic of the invention, both as to organization and methods of operation, together with the objects and advantages thereof, will be better understood from the following detailed description and the drawings wherein the invention is illustrated by way of example for the purpose of illustration and description only and are not intended as a definition of the limits of the invention:

FIG. 1 shows a schematic diagram of a wireline logging system that employs the apparatus of the current invention for acoustic logging;

FIG. 1b-1g is a schematic illustration of azimuthally segmented transmitter elements on the sonde for generating monopole, dipole and quadrupole signals;

FIG. 2 is a flow chart of one embodiment of the invention that leads to increased logging speeds for compressional and shear velocity logging;

FIG. 3 (prior art) illustrates the absorption of high frequencies in a gas saturated reservoir;

FIG. 4a shows a flow chart of one embodiment of the invention for logging in gas saturated reservoirs;

FIG. 4b shows an exemplary window of acoustic data at a plurality of receivers;

FIG. 5 is a flow chart of a method for adaptively controlling the transmitter frequency for logging that requires analysis of Stoneley waves;

FIG. 6 illustrates a flow chart of a method for adaptively altering the time sampling interval;

FIG. 7 illustrates a flow chart of a method for adaptively altering the length of the acquisition window time sampling interval of data; and

FIG. 8 is a flow chart of a method for adaptively altering the frequency of the transmitted signals based on analysis of the received signals.

### DETAILED DESCRIPTION OF THE INVENTION

A better understanding of the present invention will be obtained when the following detailed description is read with reference to the drawings. In the drawings, like elements have the same reference numeral. The invention is described with reference to a wireline logging system, though the methods of the present invention are equally applicable to MWD systems and coil tubing systems. Those of ordinary skill in the art will be able, with straightforward modifications of the hardware, to use the apparatus and methods of the present invention for MWD, coil tubing or other systems.

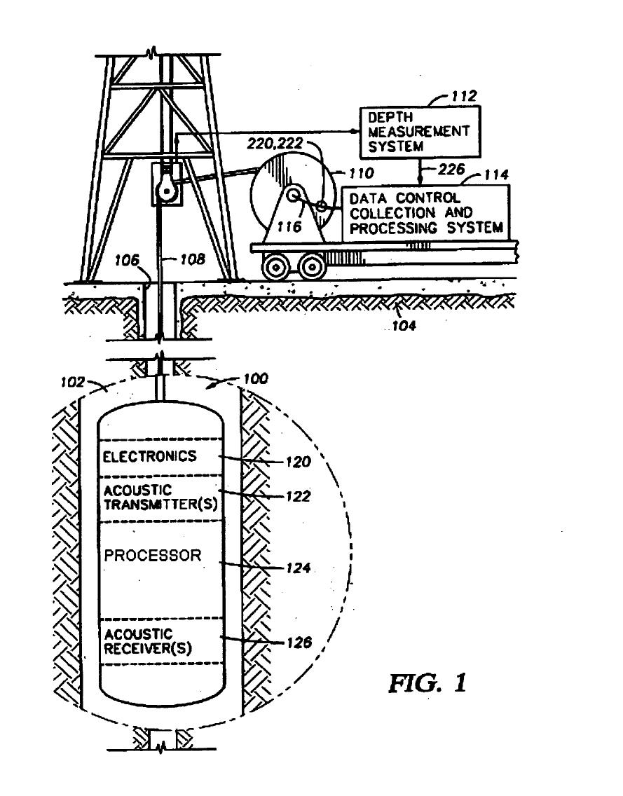

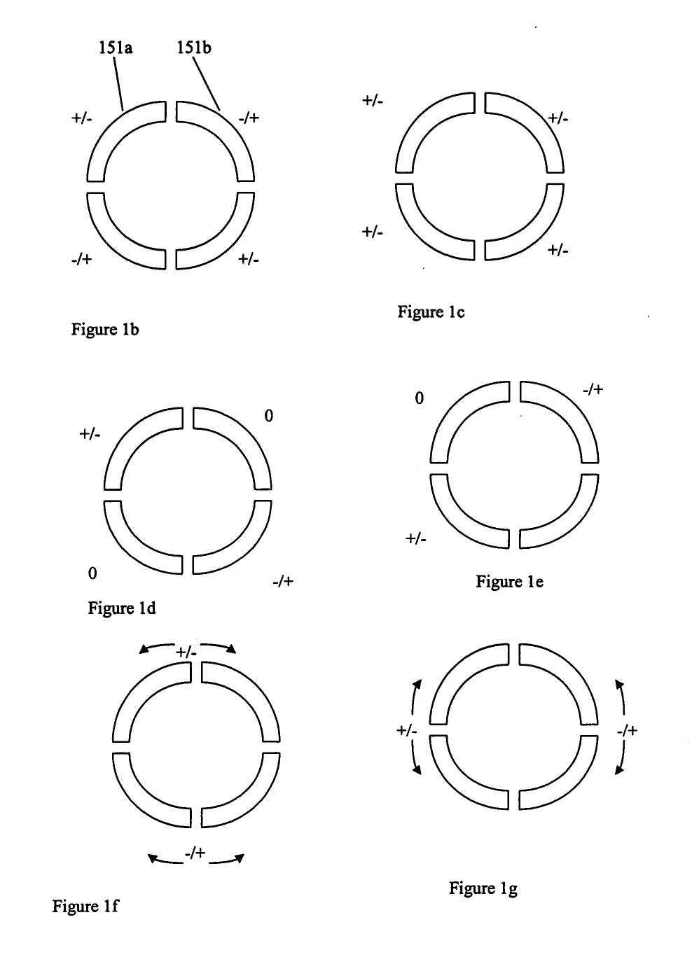

Referring now to FIG. 1a, a schematic block diagram of an acoustic well logging system suitable for use with the method of the present invention is illustrated. The system S comprises a downhole well logging sonde 100, a logging wireline cable 108, a winch 110, a depth measurement system 112 and a surface control, data collection and processing system 114. The winch 110, the depth measurement system 112 and the surface control, data collection and processing system 114 are located at the surface and are normally located in an equipment trailer (not illustrated) or logging truck (not illustrated). It will be appreciated by those skilled in the art that communication directly to the surface via a wireline cable 108, though shown for the purposes of illustration, is not necessary to the practice of the invention. The invention may be equally practiced with no direct data connection to the surface, control being maintained through a processing system located within the tool. In such a case, the data collected by the system or method may be stored in memory within the tool for later analysis.

The sonde 100 comprises electronics 120, one or more acoustic transmitter(s) 122, and one or more acoustic receiver(s) 126. One acoustic transmitter 122 and one acoustic receiver 126 are shown for illustrative purposes only. It is contemplated and within the scope of the present invention that one or more transmitter(s) 126 and one or more receiver(s) 126 may be utilized with the system, method and apparatus of the present invention as disclosed in the specification and claims. The acoustic transmitter 122 is spatially separated from the acoustic receiver 126.

The sonde 100 is placed into a well borehole 106 filled with a fluid 102. The sonde 100 is suspended in the borehole 106 by the logging cable 108. The cable 108 is rolled off of the winch 110 to lower and raise the sonde 100 in the borehole 106. The cable 108 also comprises an electronic cable 116 connected to the control, data collection and processing system 114 located at the surface. The electronic cable 116 comprises signal cables (not shown). The sonde 100 is also provided with a processor 124.

As the sonde 100 is lowered, or raised, in the borehole 106, the location of the sonde 100 in the borehole 106 is determined by a depth measurement system 112. The depth measurement system 112 sends the well depth location of the sonde 100 to the control, data collection and processing system 114. To the extent that some of the control and processing is done under control of the downhole processor 124, the depth information is also sent to the processor 124.

As the sonde 100 is lowered or preferably raised through the borehole 106, the sonde 100 passes different formation layers 104 that have different geologic and therefore different acoustic characteristics (not illustrated). One skilled in the art of acoustic well logging may determine these formation characteristics and the characteristics of fluids within the formations (also collectively known as “properties”) by their response to an acoustic wave (not illustrated) as generated by the acoustic energy source 122, modified by passage through the formation 104, received by the acoustic energy receiver 126, and collected and processed in the control, data collection and processing system 114.

FIG. 1b shows the configuration of one of the transmitters 122. A similar arrangement is used for the receivers. Each transmitter comprises four segmented transmitter elements denoted by 151a, 151b, 151c, and 151d. When the transmitters are excited with the polarities shown in FIG. 1b, a quadrupole wave is excited in the formation. When the transmitter is excited with the polarities shown in FIG. 1c, monopole wave is excited in the formation. The excitation shown in FIGS. 1d and 1e when done sequentially produces a first dipole wave and a second dipole wave with polarization orthogonal to the first dipole wave. This is called a cross-dipole configuration. An alternate method of generating a cross dipole signal is shown in FIGS. 1f and 1g. With such an arrangement, it is thus possible to excited several types of waves in the earth formation. The corresponding types of propagation modes are discussed next.

With monopole excitation, there is generally a propagating compressional wave (P-wave) in the formation, properties of which are indicative of the lithology and fluid content of the formation. In addition, a monopole excitation will also excited in the formation a shear wave (S-wave) provided the formation S-velocity is greater than the P-velocity of the borehole mud (a fast formation). In a slow formation, the formation S-wave velocity can be inferred by analysis of the Stoneley wave that propagates within the borehole. A Stoneley wave is an interface wave on the borehole wall that involves coupled motion of the formation and the fluid in the borehole. A dipole excitation will generally produce a propagating S-wave in the formation. Use of a cross dipole source (i.e., excitation in two orthogonal directions) may be used to determine an azimuthal anisotropy of the formation. Chang teaches an apparatus capable of performing both monopole and dipole excitation so that formation P- and S-wave velocities can be determined, possibly by analysis of the Stoneley waves. Quadrupole excitation is generally of importance in MWD applications where the shear wave produced in the formation is highly dispersive.

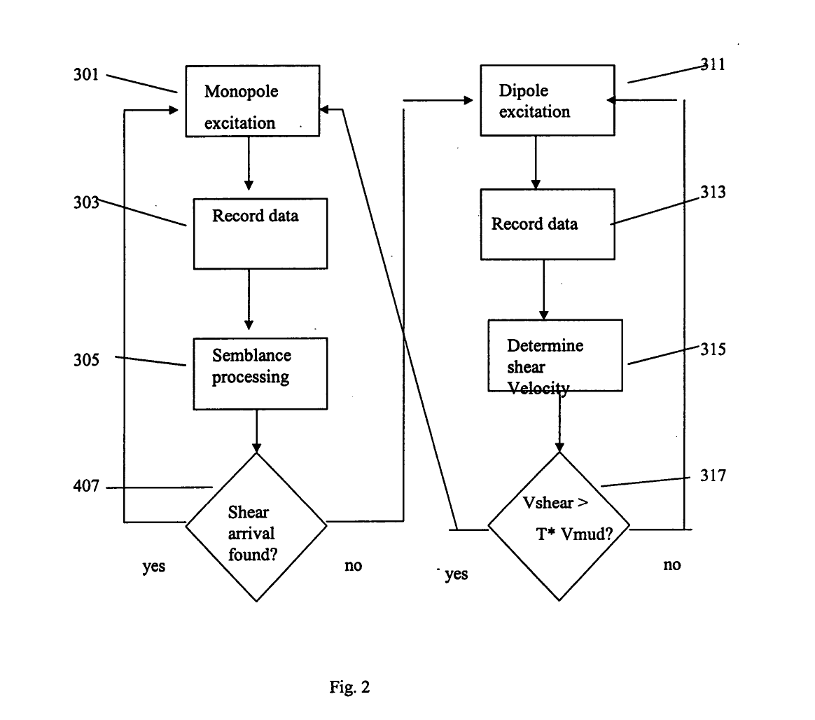

In one embodiment of the present invention, the logging speed is increased by using a dynamic switching between monopole and dipole excitation. Such a switch is done only when a single dipole signal is sufficient, i.e., there is to be no determination of azimuthal anisotropy. Rather than transmitting using a dipole and a monopole excitation at all times in order to ensure determination of S-velocities, the dipole mode is used only in slow formations. This is depicted schematically in FIG. 2.

Shown in FIG. 2 is an initial monopole excitation 301. The corresponding data received by the receiver(s) 126 is analyzed and may be either recorded 303 downhole or transmitted uphole. The receiver data are analyzed, possible using a semblance analysis 305 in either the t-x domain or in the τ-p domain to see if there is a recognizable S-arrival 307. The τ-p domain is preferred as the slowness of the arrivals is clearly identifiable. As noted above, there is always a P-arrival. If there is a recognizable S-arrival, subsequent excitation of the transmitter continues in the monopole mode. If there is not recognizable S-arrival, then the transmitter is excited in a dipole mode 311. The received data are recorded 313 and the formation S-velocity is determined by either the downhole processor or the surface processor 315. A check is mode to see if the formation S-velocity exceeds the mud velocity by a threshold factor T 317. If not, then the dipole excitation is continued.

If the formation S-velocity sufficiently large, then the dipole excitation is discontinued. The threshold is provided to avoid the possibility of rapid switching in and out of the dipole mode. It is to be noted that normally, the monopole excitation is continued so as to be able to obtain P-velocity information. When the dipole mode is not active, the formation shear velocity is determined by analysis of the Stoneley wave.

With the method of the present invention, the transmitter elements may be fired at substantially the same repetition rate. The result is that at times when the dipole mode is active, the depth sampling interval is greater. When the dipole mode is inactive, a smaller depth sampling interval is obtained. Alternatively, when the dipole mode is inactive, the logging speed can be increased with the same depth sampling interval. When the logging speed is variable, a provision may be made to alter the speed only over sufficiently long blocks of time to avoid yo-yoing of the cable.

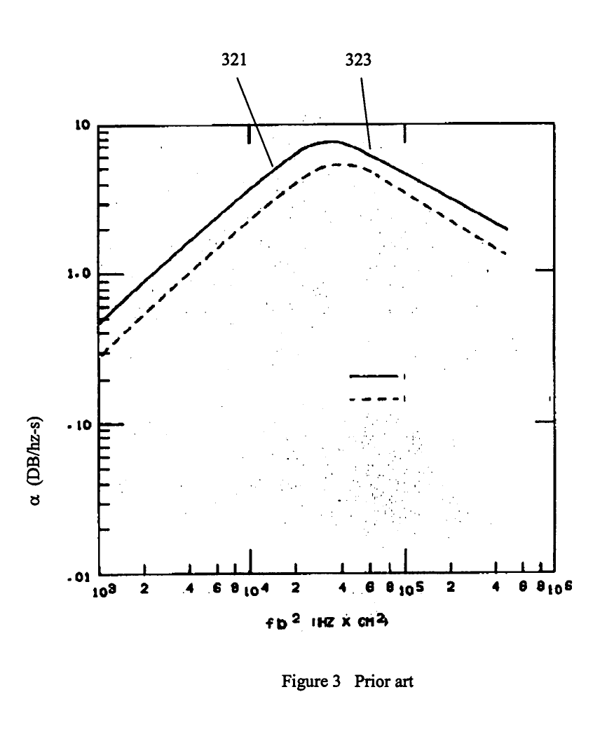

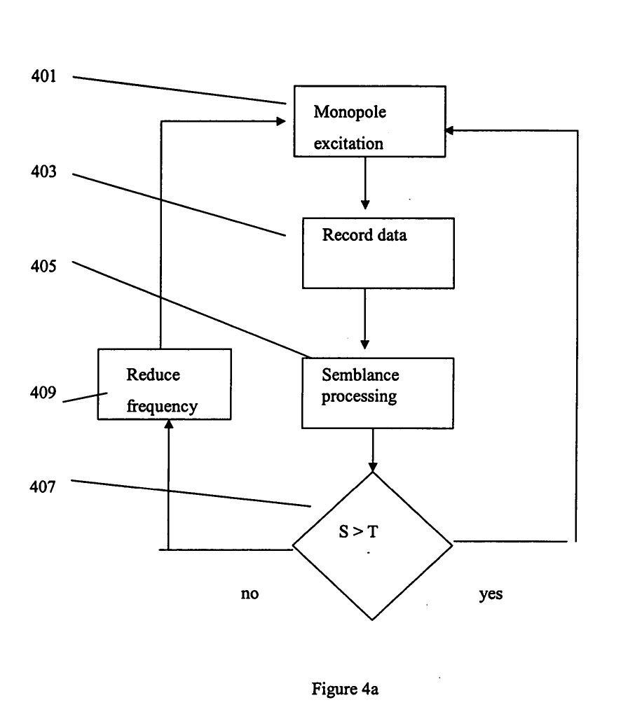

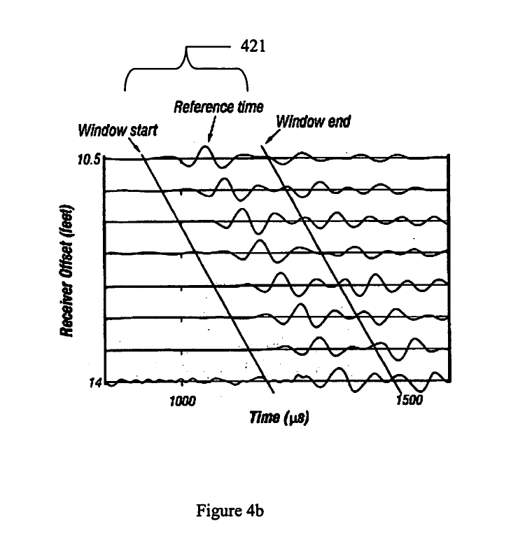

In another embodiment of the invention, the spectrum of the transmitted signal may be modified. Such a modification would be particularly important when logging in gas saturated formations. In such a formation, the attenuation of the P-wave in the formation can become quite large. This feature is depicted in FIG. 3 (from Dutta, et al.), where the abscissa is a scaled frequency and the ordinate is the attenuation factor in dB/Hz. sec. Attenuation of P-wave signals in the formation can be quite large. To deal with the absorption problem, a method illustrated in FIG. 4a is used.

For information about P-waves, only monopole excitation is needed. However, P-wave logging is done simultaneously with S-wave logging, as discussed above. A monopole signal is excited 401. The received data may be recorded, sent uphole and/or analyzed 403. Semblance processing is done in either the t-x domain or in the τ-p domain 405. A high semblance of the P-arrival over the receiver array is indicative of little change in the waveforms, i.e., little absorption. However, a low semblance is indicative of high absorption. In the present invention, the semblance of the P-arrival is compared to a threshold 407. If the semblance exceeds the threshold, the monopole excitation is not changed. If the semblance is below the threshold, then the frequency is reduced 409 for subsequent monopole excitation. By modifying the spectrum of the transmitted signal, energy is not wasted at frequencies that are highly attenuated.

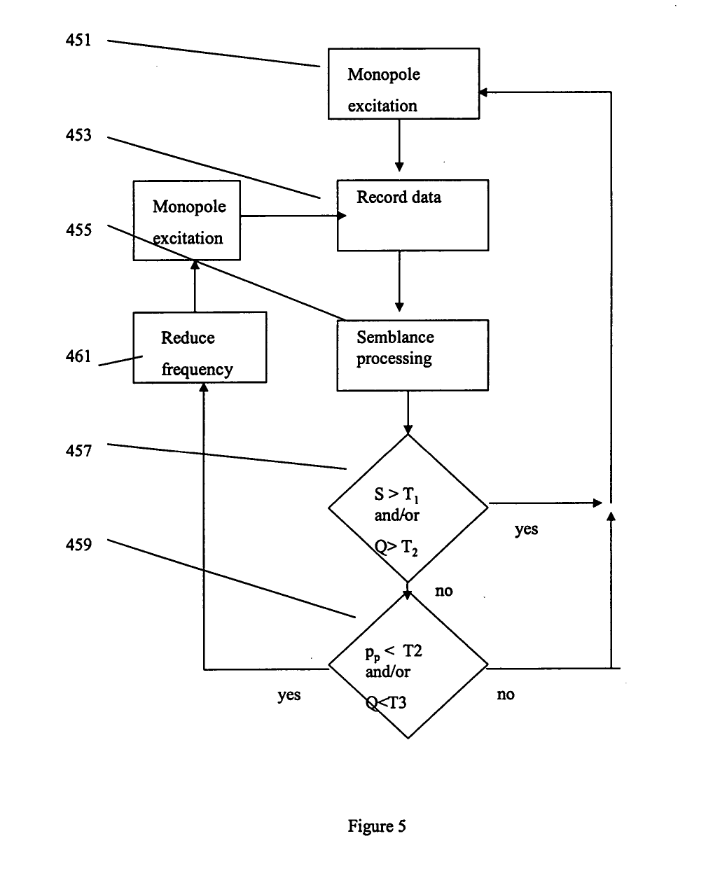

Turning next to FIG. 4b, an exemplary set of signals recorded in a receiver array is shown. The abscissa is the time and data from receivers with an offset range of 10.5 to 14 ft. (3.2 m-4.27 m) are shown. Data are typically analyzed over a reference time window depicted by 421. As noted above, in a slow formation, the signals from a monopole excitation include a P-wave and a Stoneley wave (not specifically identified in the figure). As described in Tang, et al., the formation shear velocity can be determined by analysis of the Stoneley wave. As the formation shear velocity increases, the Stoneley wave quality is degraded. This problem is addressed in an embodiment of the invention described with reference to FIG. 5.

This embodiment of the invention is based on dynamic alteration of transmitter parameters based on Stoneley wave analysis. A monopole excitation of the transmitter is done 451 and the data are recorder/transmitter/analyzed 453 as above. A semblance analysis is carried out 455. If the Stoneley wave slowness exceeds a specified threshold and/or the semblance value of the Stoneley wave exceeds another threshold 457, then no adjustment of the transmitter frequency is done. Next, if the slowness of the P-wave and/or the semblance of the P-wave is below a threshold, the frequency is reduced 461 and a monopole excitation is carried out at the reduced frequency.

In another embodiment of the invention, the acquisition is improved by dynamic alteration of the sampling rate. The recording time (trace length) is determined by the number of samples times the sampling rate. In prior art, the sampling rate and number of samples are fixed before logging to accommodate long trace lengths that are observed in slow formations. However, in fast formations only a fraction of the whole trace length utilized and the data quality could be improved by sampling it at a higher sampling rate. This is true for both monopole and dipole acquisition. This embodiment of the invention is discussed with reference to monopole data acquisition, but it is to be understood that the method is equally applicable for dipole and quadrupole acquisition.

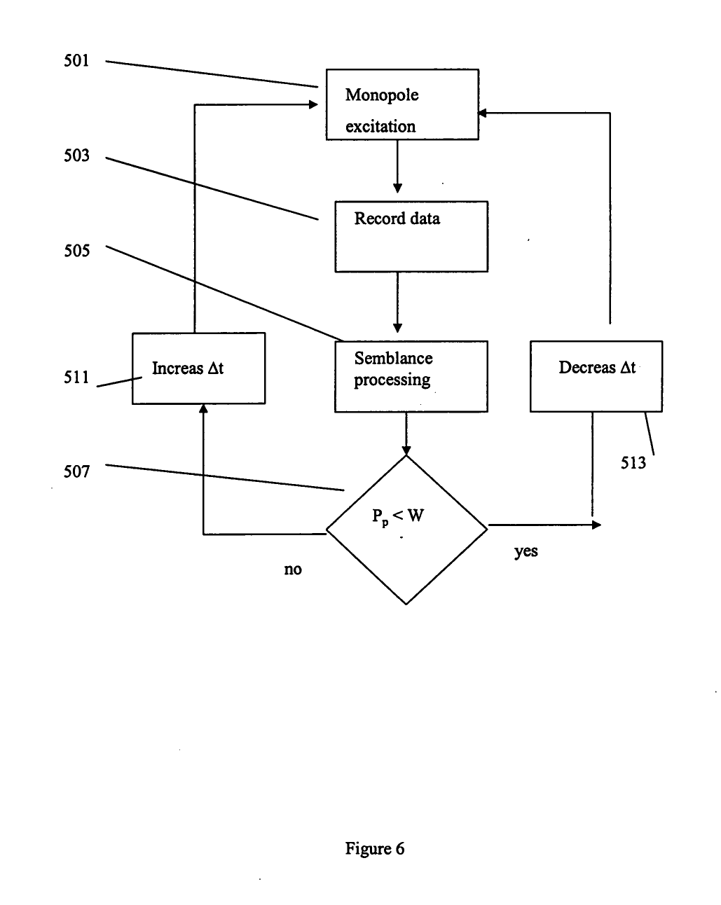

Referring now to FIG. 6, a monopole excitation is done 501. The data are recorded/transmitted/analyzed as above 503. The analysis could be in the t-x domain or in the τ-p domain, and semblance processing may be done. For the case where semblance processing is done 505 in the τ-p domain, as an example, the P-slowness is analyzed 507. If the P-slowness is within the trace length, then the sampling rate is increased, i.e., the time sampling interval t is decreased 513. If, on the other hand, the P-slowness is outside the trace length, then the sampling rate is decreased, i.e., the time sampling interval is increased 511.

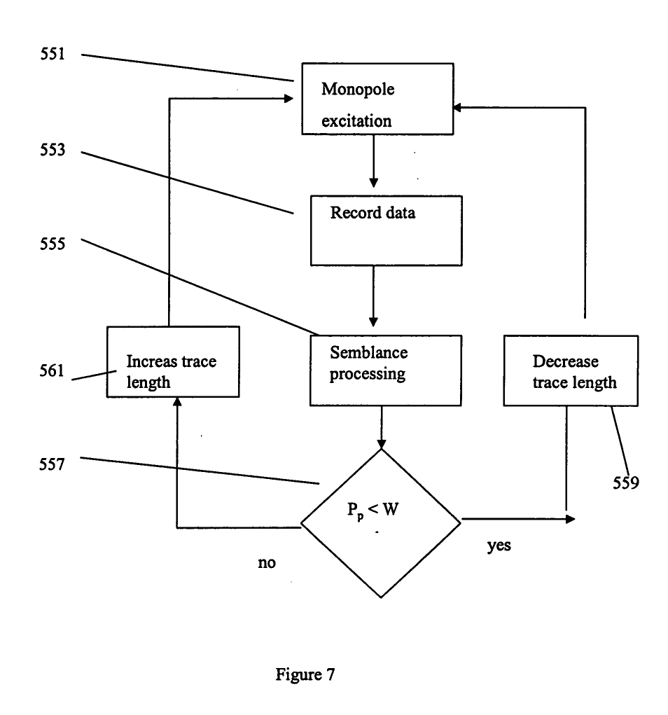

As an alternative to dynamically altering the sampling interval, the window length (421 in FIG. 4b) can be altered. In fast formations, this alteration results in an increased logging speed and reduced memory requirements. This feature is illustrated in FIG. 7. A monopole excitation is done 551. The data are recorded/transmitted/analyzed as above 553. The analysis could be in the t-x domain or in the τ-p domain, and semblance processing may be done. For the case where semblance processing is done 555 in the τ-p domain, as an example, the P-slowness is analyzed 557. If the P-slowness is within the trace length W, then the window length is decreased 559, and if, on the other hand, the P-slowness is outside the trace length, then the window length is increased 561.

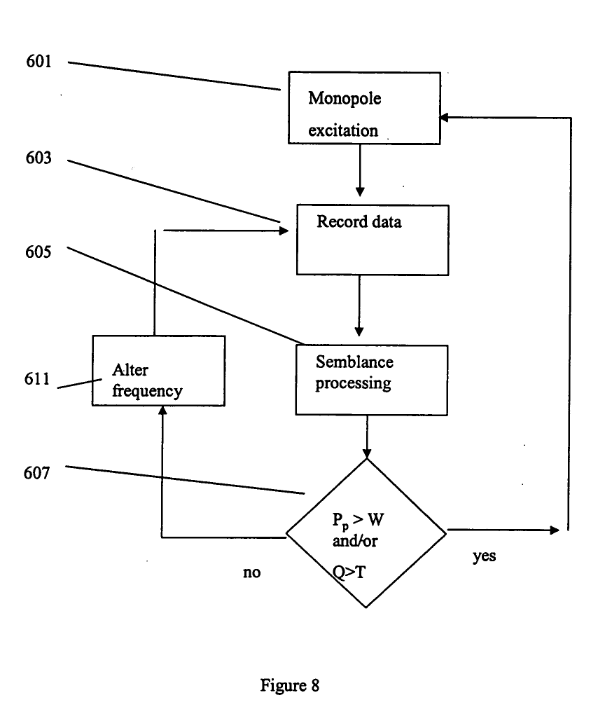

In formations where the data recording shows a high ‘road noise’, (for example a casing ring in cased hole applications)—the desired slowness could be masked by noise. By modifying the transmitter frequency one can enhance the quality of the recorded data (P-wave, S-wave, Stoneley wave) significantly. This is illustrated in FIG. 8 with reference to monopole excitation, though the method could be used for dipole excitation as well. Monopole excitation is performed 601. The data are recorded, transmitted and analyzed as discussed above 603. Semblance processing may be done 605. If, for example, the P-slowness and the P-semblance is greater than respective thresholds 605, then next monopole excitation is done. If the answer at 607 is “no”, then the frequency is reduced 611, and a single excitation is done.

The analysis of the data and the control of the acquisition may be carried out using a downhole processor, a surface processor, a processor at a remote location or a combination thereof. Implicit in the processing of the data is the use of a computer program implemented on a suitable machine readable medium that enables the processor to perform the control and processing. The machine readable medium may include ROMs, EPROMs, EAROMs, Flash Memories and Optical disks.

While the foregoing disclosure is directed to the preferred embodiments of the invention, various modifications will be apparent to those skilled in the art. It is intended that all variations within the scope and spirit of the appended claims be embraced by the foregoing disclosure.

1. A method of acquiring acoustic data indicative of properties of an earth formation, the method comprising:
(a) conveying a logging tool into a borehole into the earth formation, the logging tool including at least one transmitter and a plurality of receivers;
(b) activating the at least one transmitter to generate acoustic waves in at least one of (A) a fluid in said borehole, (B) said formation, and, (C) a wall of the borehole;
(c) receiving signals at the plurality of receivers resulting from the activation of said transmitter;
(d) analyzing the received signals; and
(c) controlling operation of the at least one transmitter based on results of said analyzing.

2. The method of claim 1 wherein the received signals comprise at least one of (i) P-waves propagating through the formation, (ii) S-waves propagating through said formation, and (iii) Stoneley waves.

3. The method of claim 1 wherein activating the at least one transmitter further comprises operating the at least one transmitter in at least one of (i) a monopole mode, (ii) a dipole mode, and (iii) a quadrupole mode.

4. The method of claim 1 wherein analyzing the signals further comprises determining a semblance of said signals.

5. The method of claim 1 wherein analyzing the signals further comprises performing a transformation to the τ-p domain.

6. The method of claim 5 wherein analyzing the signals further comprises determining a semblance of said signals in the τ-p domain.

7. The method of claim 1 wherein controlling the operation of the at least one transmitter further comprises operating said transmitter in a monopole mode and selectively activating a dipole mode.

8. The method of claim 1 wherein controlling the at least one transmitter further comprises altering a frequency of operation of the at least one transmitter.

9. The method of claim 1 wherein the analyzing of the signals further comprises determining a slowness of at least one of (i) P-waves, and, (ii) S-waves, the method further comprising altering a time sampling interval of the received signals.

10. The method of claim 1 wherein said the analyzing of the signals comprises determining a slowness of at least one of (i) P-waves, and, (ii) S-waves, the method further comprising altering a window length of the received signals.

11. The method of claim 1 wherein analyzing the signals comprises determining a noise level in the received signals and wherein controlling the at least one transmitter further comprises altering a frequency of operation of the at least one transmitter.

12. An apparatus for acquiring acoustic data indicative of properties of an earth formation, the apparatus comprising:
(a) a logging tool conveyed into a borehole into the earth formation, the logging tool including at least one transmitter that generates acoustic waves in at least one of (A) a fluid in said borehole, (B) said formation, and, (C) a wall of the borehole;
(b) a plurality of receivers which receive signals resulting from the activation of the at least one transmitter; and
(d) a processor which analyzes the received signals and controls operation of the at least one transmitter based on results of the analysis.

13. The apparatus of claim 12 wherein the at least one transmitter is operated in at least one of (i) a monopole mode, (ii) a dipole mode, and (iii) a quadrupole mode.

14. The apparatus of claim 12 wherein the processor analyzes the signals by determining a semblance of said signals.

15. The apparatus of claim 12 wherein the processor controls the operation of the at least one transmitter by selectively switching the transmitter between a monopole mode a dipole mode.

16. The apparatus of claim 12 wherein the processor controls the operation of the at least one transmitter by altering a frequency of operation of the at least one transmitter.

17. The apparatus of claim 12 wherein the processor analyzes the signals by determining a slowness of at least one of (i) P-waves, and, (ii) S-waves, and alters a time sampling interval of the received signals.

18. The apparatus of claim 12 wherein the processor analyzes the signals by determining a slowness of at least one of (i) P-waves, and, (ii) S-waves, and alters a window length of the received signals.

19. The apparatus of claim 1 wherein the processor analyzes the signals by determining a noise level in the received signals and alters a frequency of operation of the at least one transmitter.

20. The apparatus of claim 12 further comprising a wireline which conveys the logging tool into the borehole.

21. A machine readable medium for use with an apparatus which acquires acoustic data indicative of properties of an earth formation, the apparatus comprising:
(a) a logging tool conveyed into a borehole into the earth formation, the logging tool including at least one transmitter that generates acoustic waves in at least one of (A) a fluid in said borehole, (B) said formation, and, (C) a wall of the borehole; and
(b) a plurality of receivers which receive signals resulting from the activation of the at least one transmitter;
the medium comprising instructions that enable:
(c) analysis of the received signals; and
(d) control of operation of the at least one transmitter based on results of the analysis.

22. The medium of claim 21 further comprising at least one of (i) a ROM, (ii) an EPROM, (iii) an EAROM, (iv) a Flash Memory, and (v) an Optical disk.
